(19) United States
(12) Patent Application Publication
(10) Pub. No.: US 2019/0073914 A1
(43) Pub. Date: Mar. 7, 2019

(54) COGNITIVE CONTENT LABORATORY

(71) Applicant: International Business Machines Corporation, Armonk, NY (US)

(72) Inventors: Danish Contractor, Gurgaon (IN); Ying LI, Mohegan Lake, NY (US); Sandra Misiaszek, Austin, TX (US); Prasanna C. Nair, Bangalore (IN)

(21) Appl. No.: 15/693,563

(22) Filed: Sep. 1, 2017

(51) Int. Cl. G09B 5/06; G06F 17/30; G09B 7/06; G09B 7/02

(52) U.S. Cl. CPC G09B 5/06; G09B 7/02; G09B 7/06; G06F 17/30539

(57) ABSTRACT

A method, computer program product and system including inputting defined user attributes and course facets; mining existing course data for course facets; mining existing course data for user rating data; decomposing user rating data in terms of course facets and user attributes. The method, computer program product and system further including performing a course simulation for a new course including mining associations from existing course data for associations between course facets and user attributes and for associations between facets, responsive to inputting an intended target audience and course facets of the new course to be examined, predicting an expected user rating for each course facet to be examined; and when the user rating meets or exceeds predetermined criteria for each defined course facet, outputting the expected user rating and the expected user feedback to a course designer.

### BACKGROUND

The present exemplary embodiments pertain to course creation and, more particularly, pertain to predicting through the cognitive content laboratory how a course is likely to be received by the intended audience and providing dynamic feedback to the course designers.

Course creation is an expensive, labor intensive and slow process. Instruction designers may spend hundreds of hours designing course content. A course may go through multiple rounds of revisions between the teams that need the courses, the course creators and the technical validation teams. Sometimes course feedback and/or course surveys from previous users of the courses may be taken into account.

### BRIEF SUMMARY

The various advantages and purposes of the exemplary embodiments as described above and hereafter are achieved by providing, according to an aspect of the exemplary embodiments, a method comprising: responsive to inputting defined user attributes and defined course facets, mining existing course data for course facets and mining existing course data for user rating data defining user attributes; and decomposing user rating data in terms of course facets and user attributes. The method further comprises performing a course simulation for a course comprising: mining associations from existing course data for associations between course facets and user attributes and for associations between facets; responsive to inputting an intended target audience and course facets of the course to be examined, using the mined associations to predict an expected user rating for each course facet to be examined; and when the user rating meets or exceeds predetermined criteria for each defined course facet, outputting the expected user rating to a course designer.

According to another aspect of the exemplary embodiments, there is provided a computer program product for a cognitive content lab, the computer program product comprising a computer readable storage medium having program instructions embodied therewith, wherein the computer readable storage medium is not a transitory signal per se, the program instructions executable by a processor to cause the processor to perform a method comprising: responsive to inputting defined user attributes and defined course facets, mining existing course data for course facets and mining existing course data for user rating data; decomposing user rating data in terms of course facets and user attributes; and performing a course simulation for a new course comprising: mining associations from existing course data for associations between course facets and user attributes and for associations between facets; responsive to inputting an intended target audience and course facets of the course to be examined, using the mined associations to predict an expected user rating for each course facet to be examined; and when the user rating meets or exceeds predetermined criteria for each defined course facet, outputting the expected user rating to a course designer.

According to a further aspect of the exemplary embodiments, there is provided a system for a cognitive content lab comprising; at least one database for storing information; a non-transitory storage medium that stores instructions; and a processor that executes the instructions to: inputting defined user attributes; inputting defined course facets wherein a course facet is an aspect or descriptive property of a course; mining existing course data from the at least one database for course facets; mining existing course data from the at least one database for user rating data; decomposing user rating data in terms of course facets and user attributes; and performing a course simulation for a new course comprising: mining associations from existing course data for associations between course facets and user attributes and for associations between facets; responsive to inputting an intended target audience and course facets of the course to be examined, using the mined associations to predict an expected user rating for each course facet to be examined; and when the user rating meets or exceeds predetermined criteria for each defined course facet, outputting the expected user rating and the expected user feedback to a course designer.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates the system architecture for the exemplary embodiments.

FIG. 2 illustrates the pre-simulation implementation details of the exemplary embodiments.

FIG. 3 illustrates the simulation implementation details of the cognitive content lab.

FIG. 4 illustrates an example of a ratings table.

FIG. 5 is an example of a knowledge graph.

### DETAILED DESCRIPTION

The exemplary embodiments include a system that provides automated suggestions to improve a course while it is being designed based on features about the target audience, analysis of user rating and feedback on previous courses and other input.

The exemplary embodiments may provide feedback to the course designers on how their course is likely to be received by the intended audience. The intended audience is the user(s) of the course. The exemplary embodiments analyze course material, user rating and feedback and the intended audience to expose a simulation framework that gives interpretable insights to the course designers.

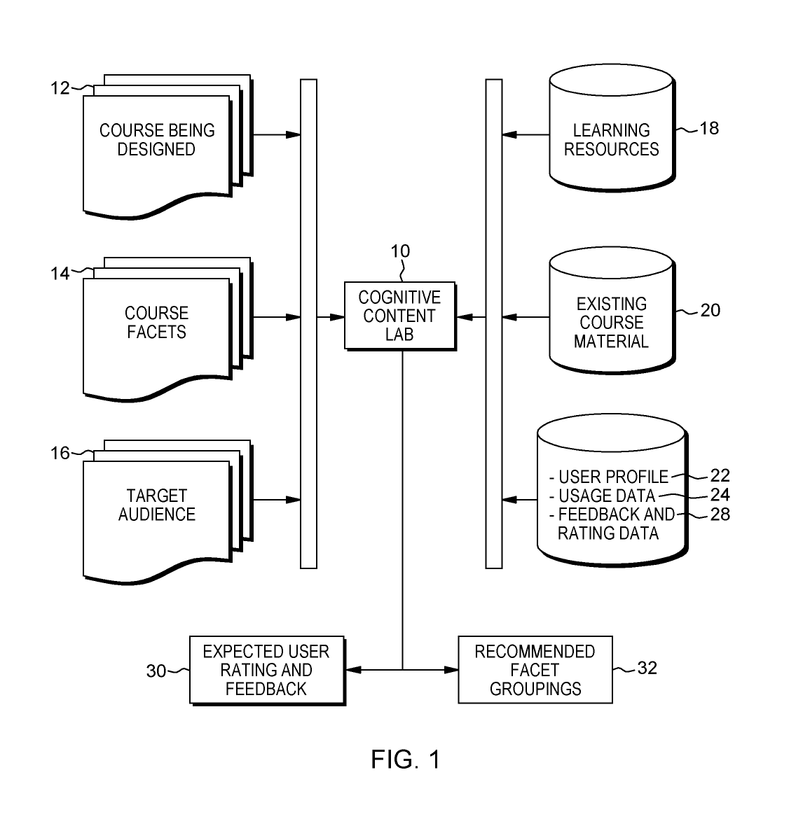

Referring to the Figures in more detail, and particularly referring to FIG. 1, there is illustrated the architecture for the exemplary embodiments. At the center of the architecture is the cognitive content lab 10, an improvement in computer technology that is a new algorithm which will receive various inputs, analyze them and predict user ratings for combinations of user attributes and course facets. The user ratings will guide the course designers in evaluating how a new course or existing course is likely to be received by a target audience.

Among these inputs are the course being designed 12 by the course designers. The input may be, for example, in the form of draft text of the course, a specification of the course in terms of styling, text and material to be used, an outline or structure of the course and any accessibility elements.

Another input may be the course facets 14 of the course being evaluated which may be a new course or an existing course. The course facets 14 (hereafter just “facets”) are the aspects or descriptive properties of a course. The facets may also include the ideas the course may explore in more detail. A nonexclusive list of some facets may be closed caption, language, illustrations, text annotations, colors, font, commentary, animation, audio and flash.

In some exemplary embodiments, facets may be subject matter independent. For example, the exemplary embodiments may learn that a course on programming for a target audience of novice engineers used audio and animation and was well received. In this context, audio and animation are the facets. Then, when designing another course for novice engineers, such as interacting with customers, the course designers may use the facets of audio and animation, knowing that these facets were well received before even though the two courses (programming and interacting with customers) are unrelated.

In other exemplary embodiments, the subject matter of the course may itself be a facet when the subject matter is germane to the course to be designed. For example, a course on programming for a target audience of novice engineers may use audio and animation but may also require hands on actual programming by the students. This course may have been well received. Then, when designing another course for novice engineers on programming, audio, animation and hands on programming may be facets to be included in the new course being designed.

Another input may be the target audience 16. The target audience are the users of the course. The target audience 16 information may include, for example, demographics of the users, job role, gender and technical specialty.

Other inputs may be in the form of historical information which may include learning resources 18, existing course material 20, user profile 22, usage data 24 and feedback and rating data 28.

Learning resources 18 may be any learning tool that is used for learning by an organization. Some examples of learning resources 18 may be lecture notes from previous courses, teaching blogs and articles from the Internet.

Existing course material 20 may be existing course material that may be similar or not similar to the course being designed. Existing course material 20 may further include related courses or a full set of courses for a given curricula. It is assumed that there is some existing course material. If there is no existing course material, the exemplary embodiments may use default/parameterized values to mimic what you would have otherwise learnt from existing course material.

The user profile 22 may contain what courses users have taken, who has taken the courses being considered in the historical information, what were their likes and dislikes, what kind of learning styles do they have, what kind of content preferences do they have, etc.

The usage data 24 may include what the user's usage pattern of previous courses was. For example, the usage data 24 may include how much time did users spend studying and what other resources the users used.

The user rating data 28 may include user rating data from users who have taken the existing course material 20 and any other course material because user characteristics as well as course characteristics need to be taken into account. Also included within the user rating data 28 may be user feedback which may include feedback from users who have taken the existing course material 20 and any other course material.

All of the above inputs may be provided to the cognitive content lab 10 which may run a course simulation and result in two outputs.

One of the outputs may be expected user rating 30 of the users for the course being designed 12. Expected feedback of the users for the course being designed 12 may also be in the output 30.

Another of the outputs may be recommended facet groupings 32. In the analysis of existing course material 20, the existing course material 20 may be mined to reveal the facets that are present in the existing course material 20. From there, it may be learned which facets are typically present together in the same course and which facets typically are not present together in the same course and further, recommend additional facets to be added to the course or recommend existing facets to be removed from the course.

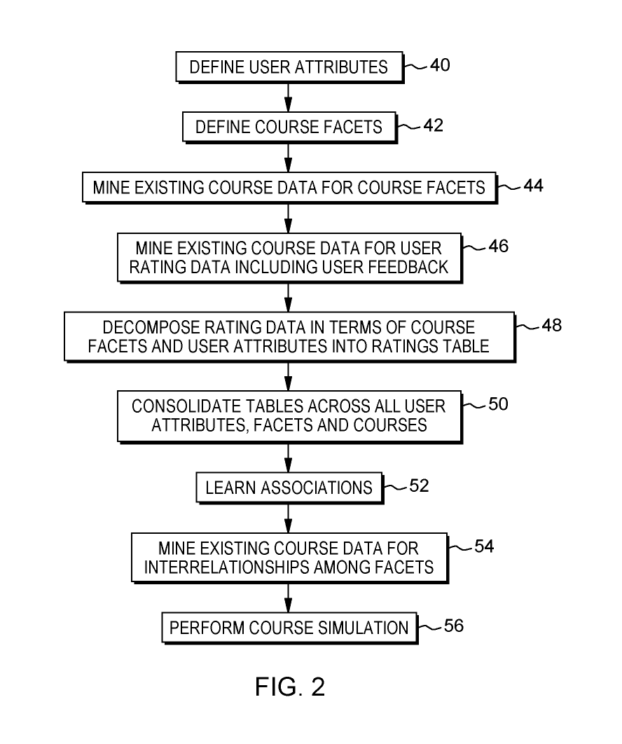

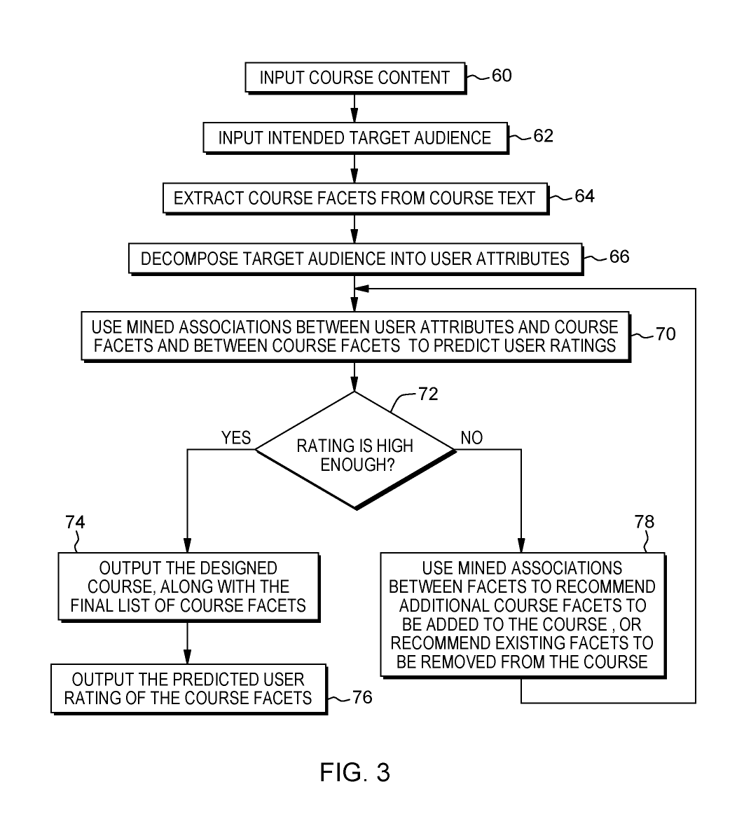

Implementation details for the exemplary embodiments are discussed in more detail with respect to FIGS. 2 and 3. FIG. 2 discusses the pre-simulation implementation details and FIG. 3 discusses the simulation implementation details of the cognitive content lab 10.

Referring now to FIG. 2, a set of features or attributes for a user are defined 40. Among these attributes may be job role, education level, gender, technical specialty, etc.

The course facets that are to be explored or undergo experimentation may be defined, 42. For example, the course facets for the course being designed may be animation, audio, text annotations and bright colors.

The existing course data may be mined 44 by retrieving the existing course data from storage 20 (FIG. 1). Existing courses are assumed or some existing learning resources are assumed. For each existing course, decompose the existing course into a set of facets that the existing course contains. Essentially, a binary vector against the defined course facets to be experimented or explored in step 42 will be obtained. That is, an indication of “0” if there is no match between an existing course facet and a defined course facet and an indication of “1” if there is a match between an existing course facet and a defined course facet.

The user rating data of the existing courses may be mined, 46 by looking up the user rating data in the rating data database 28 or other database which may contain user rating data. It is assumed that there is some historical rating data. If there is no historical rating data, default values for the historical rating data may be specified. This may include any rating data from the historical existing courses such as the rating score, the comments, the likes/dislikes, other sentiments, etc.

User feedback from the existing courses may also be mined by looking up the user feedback from the rating data database 28. Feedback may also be obtained from other sources such as user comments, upvotes, downvotes, etc. Sentiment/facet associations can be used to generate numeric scores based on the degree of sentiment expressed. For example, sentiments may be encoded to a value between −1 (very negative) and +1 (very positive) and the presence of a facet associated with it will be indicated as a binary feature.

The user rating may be converted into numerical scores such as on the scale of 0 to 1. For example, if the user rating is “strongly recommended”, the user rating may be considered to be 1.0, while if the user rating is “neutral”, the score may be considered to be 0.5. Once data is collected from various sources (such as feedback and user rating), some data cleaning and data normalization may need to be performed to transform all data attributes to the same numerical range (e.g. 0 to 1).

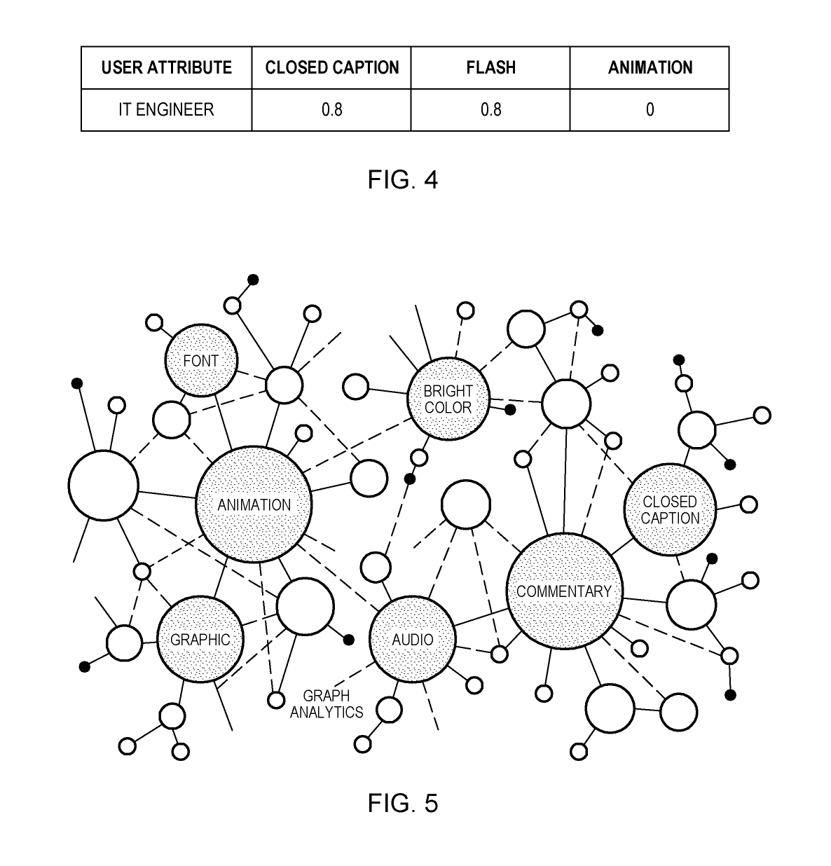

The user rating score may be decomposed in terms of course facets and user attributes and placed into a ratings table, 48. Referring to FIG. 4, an example is illustrated where the user attribute is for an IT engineer, the course the user rated has “closed caption” and “flash” facets, and each of those facets was given a user rating of 0.8. Since “animation” was not part of the course, the user rating is 0.0.

The data across all users and all rated courses and course facets may be consolidated 50. The consolidation may result in a final number which may be a weighted sum. For example, assume five IT engineers took a course in which one of the course facets was closed caption. Two IT engineers rated the course facet 0.8, one IT engineer rated the course facet 0.5 and two IT engineers rated the course facet 0.3. Then, the final number for closed caption is: (0.8*2+0.5+0.3*2)/5=0.54). Note that the matrix may get very sparse if there are a long list of course facets and many different attribute values. It may be preferred to create one matrix for each attribute as shown in FIG. 4. That is, for the matrix of job role attribute, the number of rows may be the total number of different job roles, and the number of columns may be the total number of facets

Once the data across all users and all rated courses and course facets is consolidated as described with respect to step 50, the associations between and among users and course facets may be learned 52 by using, for example, the Apriori algorithm or other approaches. The Apriori algorithm is an algorithm for frequent item set mining and association rule learning over transactional databases. It proceeds by identifying the frequent individual items in the database and extending them to larger and larger item sets as long as those item sets appear sufficiently often in the database. The frequent item sets determined by the Apriori algorithm can be used to determine association rules which highlight general trends in the database. Association rule learning is a rule-based machine learning method for discovering interesting relations between variables in large databases. It is intended to identify strong rules discovered in databases using some measures of interestingness.

Among the associations to be learned from the Apriori algorithm are the associations between the user attributes and the facets and the associations between facets.

Association may be understood as correlation. An example of deriving association at step 52 is: from the consolidated table achieved at step 50 shown in FIG. 4, it is learned that a user attribute of “IT engineer” tends to give a rating within the range of [0.5, 0.8] on the course facet “caption”.

Various existing algorithms may be applied to derive such association rules. The Apriori algorithm is one of them, which has a good performance.

The whole set of existing course data may be mined to understand the interrelationships among different course facets 54. In one exemplary embodiment, the associations from step 52 may be used to learn the interrelationships among different course facets 54. For example, facet1 usually appears together in the same course with facet4 while facet2 and facet3 never appear together in one course. The recommended facet groupings 32 (FIG. 1) is an output of the mining of the interrelationships among different course facets 54.

A knowledge graph (may also be called a knowledge map) may be built and outputted to the course designer to understand the interrelationships among the different course facets. A graph may be built where each node is a facet and an edge is drawn between two nodes if the two facets co-occur in a course/module with a weight on each edge that has a normalized count of occurrence. Knowledge graphs can be of many types—learning knowledge graphs, facet graphs etc. FIG. 5 is an example of a knowledge graph where animation, font, graphic, bright color, audio, commentary and closed caption are all facets. In the knowledge graph of FIG. 5, for example, animation occurs in the same course/module with font and graphic with animation being the more frequent occurrence.

At this point, a course simulation in the cognitive content lab 10 is ready to run 56. This course simulation may be for the course that is being designed or even for an existing course.

Referring now to FIG. 3, the simulation in the cognitive content lab 10 may use various inputs. One input may be the draft text or other course description 60 described with respect to the course being designed 12 (FIG. 1). For an existing course, the input may be the description of the course. The draft text or other course description 60 is a source of identifying courses to base the simulation on. Another input may be the intended target audience 62 described with respect to the target audience 16 (FIG. 1). A further input may be the course facets to be tested 64 described with respect to the existing course facets 14 (FIG. 1). These course facets may be extracted from the course text.

The target audience may be decomposed into a list of user attribute values 66, for example, demographics of the users, job role, gender and technical specialty, as described previously.

In one exemplary embodiment, the mined associations (step 52 FIG. 2) between the user attributes and the existing course facets and between the existing course facets may be used to predict the expected user rating for each course facet for each user attribute under consideration 70. In a greatly simplified example, if the mined associations indicate that for a target audience of novice engineers, animation and audio facets result in a higher user rating, then similar facets may be used for the same target audience but in a new course being designed.

The course designers may set a qualitative criteria for the expected user rating. If the expected user rating is determined, box 72, according to the course designers' qualitative criteria, to be high enough, the “YES” path is followed. Otherwise, the “NO” path is followed. In one example, a user rating scale may have been established when user rating data was mined in step 46, FIG. 2. The course designers may set a rating of 0.5 for this particular course as being high enough for the “YES” path.

Following the “YES” path, the designed course along with the final list of course facets in the designed course may be output, box 74.

In addition, the expected user rating by user attribute for each course facet may be output to the course designer, 76 for use by the course designer in designing the course.

Following the “NO” path, the mined associations between user attributes and facets are used to recommend facets to be added to the course or recommend existing facets to be removed from the course, box 78. The cognitive content lab 10 uses the knowledge on facet groupings from step 54 in FIG. 2 to better design the course content, as indicated by Box 78, to add or delete facets. Then, the process may loop back with the added or deleted facets to the mined associations (step 52 FIG. 2) between the user attributes and the existing course facets to again predict the expected user rating for each course facet for each user attribute under consideration 70.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A method comprising;
responsive to inputting defined user attributes and defined course facets, mining existing course data for course facets and mining existing course data for user rating data defining user attributes;
decomposing user rating data in terms of course facets and user attributes;
performing a course simulation for a course comprising:
mining associations from existing course data for associations between course facets and user attributes and for associations between facets;
responsive to inputting an intended target audience and course facets of the course to be examined, using the mined associations to predict an expected user rating for each course facet to be examined; and
when the user rating meets or exceeds predetermined criteria for each defined course facet, outputting the expected user rating to a course designer.

2. The method of claim 1 wherein when the user rating does not meet or exceed the predetermined criteria for each defined course facet, using the mined associations for interrelationships among course facets and recommending additional course facets to be added or existing course facets to be deleted in the course based on the mined course facets grouping.

3. The method of claim 2 further comprising repeating the course simulation with the recommended course facet addition or deletion.

4. The method of claim 1 further comprising outputting the recommended course facet groupings.

5. The method of claim 1 wherein a course facet is an aspect or descriptive property of a course.

6. The method of claim 4 wherein the course facet may further include ideas the course may explore in more detail.

7. The method of claim 1 wherein performing the course simulation further comprising decomposing the target audience into user attributes.

8. A computer program product for a cognitive content lab, the computer program product comprising a computer readable storage medium having program instructions embodied therewith, wherein the computer readable storage medium is not a transitory signal per se, the program instructions executable by a processor to cause the processor to perform a method comprising:
responsive to inputting defined user attributes and defined course facets, mining existing course data for course facets and mining existing course data for user rating data;
decomposing user rating data in terms of course facets and user attributes;
performing a course simulation for a new course comprising:
mining associations from existing course data for associations between course facets and user attributes and for associations between facets;
responsive to inputting an intended target audience and course facets of the course to be examined, using the mined associations to predict an expected user rating for each course facet to be examined; and
when the user rating meets or exceeds predetermined criteria for each defined course facet, outputting the expected user rating to a course designer.

9. The computer program product of claim 8 wherein when the user rating does not meet or exceed the predetermined criteria for each defined course facet, using the mined associations for interrelationships among course facets and recommending additional course facets to be added or existing course facets to be deleted in the course based on the mined course facets grouping.

10. The computer program product of claim 9 further comprising repeating the course simulation with the recommended course facet addition or deletiongrouping added or avoided.

11. The computer program product of claim 8 further comprising outputting the recommended course facet groupings.

12. The computer program product of claim 8 wherein a course facet is an aspect or descriptive property of a course.

13. The computer program product of claim 11 wherein the course facet may further include ideas the course may explore in more detail.

14. The computer program product of claim 8 wherein performing the course simulation further comprising decomposing the target audience into user attributes

15. A system for a cognitive content lab comprising;
at least one database for storing information;
a non-transitory storage medium that stores instructions; and
a processor that executes the instructions to:
inputting defined user attributes;
inputting defined course facets wherein a course facet is an aspect or descriptive property of a course;
mining existing course data from the at least one database for course facets;
mining existing course data from the at least one database for user rating data;
decomposing user rating data in terms of course facets and user attributes;
performing a course simulation for a new course comprising:
mining associations from existing course data for associations between course facets and user attributes and for associations between facets;
responsive to inputting an intended target audience and course facets of the course to be examined, using the mined associations to predict an expected user rating for each course facet to be examined; and
when the user rating meets or exceeds predetermined criteria for each defined course facet, outputting the expected user rating and the expected user feedback to a course designer.

16. The system of claim 15 wherein the processor executes instructions when the user rating does not meet or exceed the predetermined criteria for each defined course facet, using the mined associations for interrelationships among course facets and recommending additional course facets to be added or existing course facets to be deleted in the course based on the mined course facets grouping.

17. The system of claim 15 wherein the processor executes instructions further comprising repeating the course simulation with the recommended course facet addition or deletion.

18. The system of claim 15 wherein the processor executes instructions further comprising outputting the recommended course facet groupings.

19. The system of claim 15 wherein the course facet may further include ideas the course may explore in more detail.

20. The method of claim 19 wherein the instructions for performing the course simulation further comprising decomposing the target audience into user attributes and wherein examining expected user rating and expected user feedback for each course facet to be examined including examining expected user rating and expected user feedback by user attribute.
